(19) United States
(12) Patent Application Publication
(10) Pub. No.: US 2009/0290769 A1
(43) Pub. Date: Nov. 26, 2009

(54) MEDICAL IMAGE PROCESSING METHOD

(75) Inventor: Kazuhiko Matsumoto, Tokyo (JP)

Correspondence Address: PEARNE & GORDON LLP, 1801 EAST 9TH STREET, SUITE 1200, CLEVELAND, OH, 44114-3108, US

(73) Assignee: ZIOSOFT INC, Tokyo (JP)

(21) Appl. No.: 12/469,803

(22) Filed: May 21, 2009

(30) Foreign Application Priority Data
May 22, 2008 (JP) P2008-134702

(51) Int. Cl. G06K 9/00; G06T 11/20

(52) U.S. Cl. 382/128; 345/442

(57) ABSTRACT

The present disclosure relates to a medical image processing method for manipulating a curve using a pointing device. The method includes: (a) accepting a first point on the curve specified by the pointing device; (b) reading a first time; (c) reading a second time when a point specified by the pointing device is moved to a second point from the first point; (d) determining a new curve based on a position of the second point, the second time, and the first time; (e) displaying said new curve; (f) reading a third time and a third point specified by the pointing device; (g) determining a further new curve based on a position of the third point, the third time, and the first time or the second time; and (h) displaying said further new curve.

This application is based on and claims priority from Japanese Patent Application No. 2008-134702, filed on May 22, 2008, the entire contents of which are hereby incorporated by reference.

### BACKGROUND OF THE INVENTION

1. Technical Field

The present disclosure relates to a medical image processing method and a medical imaging apparatus.

2. Related Art

FIGS. 14A to 16B are drawings to describe an operation of setting an arbitrary curve in a three-dimensional space in a computer. It is not easy for an operator to set an arbitrary curve (free-form curve) in a three-dimensional space in a computer. For example, as shown in FIG. 14A, to set a Bezier curve 101, it is necessary to operate control points 102 and 103 in a three-dimensional space, and thus a skill is required. Alternatively, as shown in FIG. 14B, a large number of nodes 104 to 109 need to be specified and it is considerably difficult to form a curve of a shape as desired by the user.

Particularly, as shown in FIG. 15A, if a curve 110 is created with tracking algorithm, a very large number of nodes 111 to 121 may be created. Thus, an undesirable result is expected if the user operates the individual nodes 111 to 121.

For example, if an attempt is made to change the curve a little, only one node 116 may move largely or a very long link 122 may occur as shown in FIG. 15B. Further, other nodes 117, 118, etc., may be brought close to any desired curve if the user operates, but it is extremely difficult to operate in a three-dimensional space because operation in the depth direction relative to the plane of the drawing is necessary.

If the user creates a curve 123 manually, the number of created nodes 124, 125, and 126 may be too small (FIG. 16A). In this case, if one of the nodes is operated or a new node is added carelessly, an undesirable result may be expected.

The desired shape is not provided by adding single node 127, as shown in FIG. 16B. In addition, a side effect may occur as indicated by reference numeral 128. Thus, it is not easy to increase or decrease the number of nodes. In operation, it is roundabout to directly manipulate nodes.

FIGS. 17 to 19B are drawings to describe curves in a medical image. FIG. 17 is a drawing (#1) to show how curves are set in blood vessels of the tissues of a human body. For such a medical image, the path of the blood vessel in an organ is represented as a curve and the curve is set while seeing the medical image. However, it is further difficult to set an arbitrary curve in a three-dimensional space of the medical image or the like for operator. In the medical image, a large number of nodes are required because it is necessary to accurately trace the tissues; on the other hand, if an excessive number of nodes are present, it is difficult to correct the curve. Further, if an excessive number of nodes are present, the execution speed of another image processing algorithm using the curve information decreases.

FIGS. 18A and 18B are the drawings (#2) to describe curves in a medical image and shows how a center line is set in a stenotic blood vessel 134. Stenotic portions of the blood vessel are present at the positions indicated by reference numerals 131 and 132 in FIG. 18A. A reference numeral 133 in FIG. 18A denotes the center line of the blood vessel 134 recognized by the tracking algorithm. On the other hand, a reference numeral 135 in FIG. 18B denotes a desirable center line of the blood vessel 134. Thus, in order to change the center line 133 of the blood vessel which is recognized by the tracking algorithm to the center line 135 of the blood vessel which is useful for a diagnosis, the correction based on the judgment of an operator is required.

FIGS. 19A and 19B are the drawings (#3) to describe curves in a medical image and are schematic representations for observing an orthogonal section of a blood vessel. Reference numerals 141 to 144 in FIG. 19A denote orthogonal sections recognized by the tracking algorithm and reference numerals 145 to 148 in FIG. 19B denote orthogonal sections matching the subjective judgment of an operator. Thus, when the operator observes the orthogonal section of a blood vessel, it is necessary to display the orthogonal section matching the subjective judgment of the operator.

FIG. 20 is the drawing (#4) to describe curves in a medical image and shows a display image displayed by an actual medical image processing apparatus. Thus, in the display image, a curve 151 represents the path of blood vessels in an organ, and is displayed together with an image 150 visualizing the tissues. Further, the cross-section images 152a, 152b, and 152c showing the respective sections which are orthogonal to the curve 151 are displayed.

To input a two-dimensional graphic interactively using a personal computer or interactive NC, for example, JP-A-63-80368 describes a graphic input apparatus having a GUI for determining the type (determine end point or middle point of a curve) of new added node in response to the sagging time of a cursor.

Also, as the curve setting method of a golf game, the method of determining a trajectory of the shot depending on the time pressing a button is known. For example, JP-A-2000-137833 describes a ballistic calculation method used with a computer golf-game using a network (e.g., World Wide Web (WWW) environment of the Internet).

Thus, in the related-art method as described above, it is not easy to set an arbitrary curve (free-form curve) in a computer. For example, in order to set a Bezier curve, it is necessary to set a control point and specify a large number of nodes and thus it is difficult to form a curve shape as desired by the user. Particularly, for a medical image, it is not easy to set a free-form curve while seeing the medical image.

### SUMMARY OF THE INVENTION

Exemplary embodiments of the present invention address the above disadvantages and other disadvantages not described above. However, the present invention is not required to overcome the disadvantages described above, and thus, an exemplary embodiment of the present invention may not overcome any of the problems described above.

Accordingly, it is an aspect of the present invention to provide a medical image processing method and a medical imaging apparatus, which enable the user to perform intuitive and easy operation to adjust or correct a curve set mainly by tracking algorithm and obtains any desired curve regardless of the number of nodes.

According to one or more aspects of the present invention, there is provided a medical image processing method for manipulating a curve using a pointing device. The method comprises: (a) accepting a first point on the curve specified by the pointing device; (b) reading a first time; (c) reading a second time when a point specified by the pointing device is moved to a second point from the first point; (d) determining a new curve based on a position of the second point, the second time, and the first time; (e) displaying said new curve; (f) reading a third time and a third point specified by the pointing device; (g) determining a further new curve based on a position of the third point, the third time, and the first time or the second time; and (h) displaying said further new curve.

According to one or more aspects of the present invention, there is provided a medical imaging apparatus. The apparatus comprises: a volume data generating section that generates volume data; a curve generation section that generates a curve based on the volume data; a user interface section that generates a control signal in response to a signal from a pointing device; a curve adjustment section that manipulates the curve generated in the curve generation section based on the control signal generated in the user interface section; and a display section that displays the new curve or the further new curve. The curve adjustment section comprises: a first time record processing section that records a first time when a first position on the curve specified by the pointing device is accepted; a second time record processing section that records a second time when a point specified by the pointing device is moved to a second point from the first point; a third time record processing section that records a third time when a point specified by the point device is moved to a third point from the second point; and a curve determination processing section that determines: (i) a new curve based on a position of the second point, the second time and the first time; and (ii) a further new curve based on a position of the third point, the third time, and the first time or the second time.

Other aspects of the invention will be apparent from the following description, the drawings and the claims.

### BRIEF DESCRIPTION OF THE DRAWINGS

In the accompanying drawings:

FIG. 1 is the drawing to schematically show a computed tomography (CT) apparatus used with an image processing method according to an exemplary embodiment of the present invention;

FIG. 2 is the drawing (#1) to describe the case where a curve is operated according to the time required for mouse operation in Example 1 of the exemplary embodiment;

FIGS. 3A to 3D are the drawings (#2) to describe the case where a curve is operated according to the time required for mouse operation in Example 1 of the exemplary embodiment;

FIG. 4 is the drawing to describe a curve changing method 1 in Example 1 of the exemplary embodiment;

FIG. 5 is the drawing to describe a curve changing method 2 in Example 1 of the exemplary embodiment;

FIG. 6 is the drawing to describe a curve changing method 3 in Example 1 of the exemplary embodiment;

FIG. 7 is the drawing (#1) to describe the case where a curve 31 is operated according to the mouse dragging speed in Example 2 of the exemplary embodiment;

FIGS. 8A and 8B are the drawings (#2) to describe the case where the curve 31 is operated according to the mouse dragging speed in Example 2 of the exemplary embodiment;

FIG. 9 is the drawing to describe the case where a curve 36 is operated by performing physical simulation in Example 3 of the exemplary embodiment;

FIGS. 10A to 10D are the drawings to describe the case where an image depending on a curve is updated during operation in Example 4 of the exemplary embodiment;

FIGS. 11A and 11B are the drawings to describe the effect of Example 4 of the exemplary embodiment;

FIGS. 12A to 12C are the drawings to describe the case where user's command change is accepted while a curve is changing in Example 5 of the exemplary embodiment;

FIG. 13 is the flowchart to describe a curve correction method according to the exemplary embodiment of the invention;

FIGS. 14A and 14B are the drawings (#1) to describe an operation of setting an arbitrary curve in a computer in a related art;

FIGS. 15A and 15B are the drawings (#2) to describe an operation of setting an arbitrary curve in a computer in a related art;

FIGS. 16A and 16B are the drawings (#3) to describe an operation of setting an arbitrary curve in a computer in a related art;

FIG. 17 is the drawing (#1) to describe curves in a medical image in a related art;

FIGS. 18A and 18B are the drawings (#2) to describe curves in a medical image in a related art;

FIGS. 19A and 19B are the drawings (#3) to describe curves in a medical image in a related art; and

FIG. 20 is the drawing (#4) to describe curves in a medical image in a related art.

### DETAILED DESCRIPTION OF EXEMPLARY EMBODIMENTS OF THE INVENTION

According to exemplary embodiments of the present invention, when the user operates a curve, motion required for the operation is used as a parameter. Accordingly, a curve set mainly by tracking algorithm can be adjusted or corrected.

Further, according to exemplary embodiments of the present invention, for operation of the curve, motion information required for the operation is used. For example, (a) the curve is operated according to the time required for the operation; (b) the curve is operated according to the operation speed; (c) the curve is changed consecutively; and (d) user's command change is accepted while the curve is changing.

Accordingly, when the curve set mainly by the tracking algorithm is adjusted or corrected, the user can perform intuitive and easy operation and can also obtain any desired curve regardless of the number of nodes.

Exemplary embodiments of the present invention will be described with reference to the drawings hereinafter.

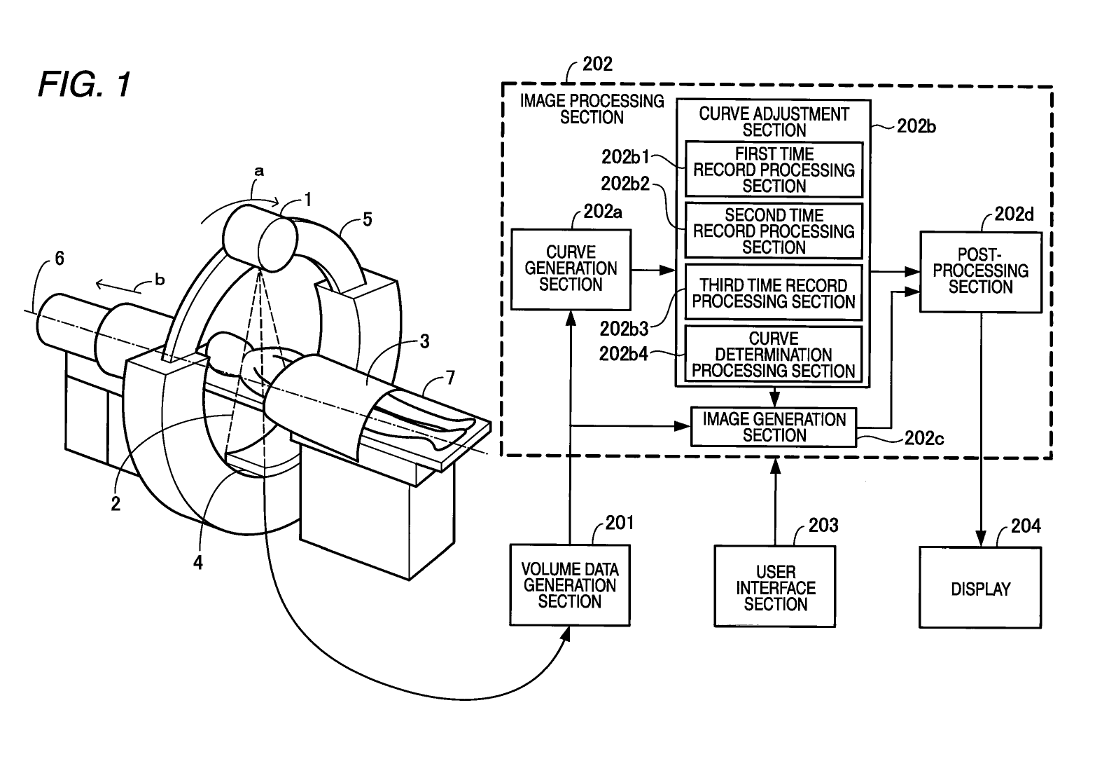

FIG. 1 schematically shows a computed tomography (CT) apparatus for acquiring volume data used with an image processing method according to an exemplary embodiment of the present invention. The computed tomography apparatus visualizes the tissue of a specimen. An X-ray beam bundle 2 shaped like a pyramid (shown by the chain line in the figure) is radiated from an X-ray source 1. The X-ray beam bundle 2 passes through a specimen (a patient 3) and is applied to an X-ray detector 4. The X-ray source 1 and the X-ray detector 4 are arranged on a ring-like gantry 5 to face each other in the exemplary embodiment. The ring-like gantry 5 is supported on a retainer (not shown in the figure) so as to rotate (see arrow “a”) around a system axis 6 passing through the center point of the gantry.

The patient 3 lies down on a table 7 through which an X ray passes in the exemplary embodiment. The table 7 is supported by a retainer (not shown) so as to move along the system axis 6 (see arrow “b”).

Therefore, the X-ray source 1 and the X-ray detector 4 can rotate around the system axis 6 and can also move relatively to the patient 3 along the system axis 6. Therefore, the patient 3 can be projected at various projection angles and at various positions relative to the system axis 6. An output signal of the X-ray detector 4 generated at the time is supplied to a volume data generation section 201, and then converts the signal into volume data.

In a sequence scanning, scanning is executed for each layer of the patient 3. Then, the X-ray source 1 and the X-ray detector 4 rotate around the patient 3 with the system axis 6 as the center, and the measurement system including the X-ray source 1 and the X-ray detector 4 photographs a large number of projections to scan two-dimensional tomograms of the patient 3. A tomographic image for displaying the scanned tomogram is reconstructed based on the acquired measurement values. The patient 3 is moved along the system axis 6 each time in scanning successive tomograms. This process is repeatedly performed until all tomograms of interest are captured.

On the other hand, during spiral scanning, the measurement system including the X-ray source 1 and the X-ray detector 4 rotates around the system axis 6 while the table 7 moves continuously in the direction of the arrow “b”. That is, the measurement system including the X-ray source 1 and the X-ray detector 4 moves continuously on the spiral orbit relatively to the patient 3 until all regions of interest of the patient 3 are captured. In the exemplary embodiment, the computed tomography apparatus shown in the figure supplies a large number of successive tomographic signals in the diagnosis range of the patient 3 to the volume data generation section 201.

The volume data generated by the volume data generation section 201 are the inputs to a curve generation section 202a and an image generation section 202c in an image processing section 202. The curve generation section 202a generates the curve representing the path of an organ by automatic processing and outputs the curve to a curve adjustment section 202b. The image generation section 202c generates, based on the volume data, an image visualizing an organ, such as a volume rendering image, a Multi Planer Reconstruction (MPR) image, or a Curved multi Planer Reconstruction (CPR) image, and then outputs the generated image to a post-processing section 202d.

The curve adjustment section 202b adjusts or corrects (manipulates) the curve generated in the curve generation section 202a based on a signal input from a user interface section 203. The curve adjustment section includes a first time record processing section 202b1, a second time record processing section 202b2, a third time record processing section 202b3, and a curve determination processing section 202b4. The first time record processing section 202b1 records the first time when or after the user starts a move operation of a pointing device. The second time record processing section 202b2 records the second time if the user moves the point specified by the pointing device to a second point in a three-dimensional space. The third time record processing section 202b3 records the third time if the user moves the point specified by the pointing device to a third point in the three-dimensional space. The curve determination processing section 202b4 determines a new curve based on the position of the second point, the second time, and the first time. The curve determination processing section 202b4 determines a further new curve based on the position of the third point, the third time, and the first time. The position of the second point and the position of the third point may be the same.

Also, the curve adjustment section 202b may include a moving speed record processing section that reads a moving speed of the pointing device when the pointing device is moved from the first point. In a case where the moving speed record processing section is included in the curve adjustment section 202b, the curve determination processing section 202b4 determines the further new curve based on the moving speed in addition to the position of the third point, the third time and the first time or second time. (For details, see Example 2 described below.)

Also, the curve determination processing section 202b4 may determine the new curve by simulating a curve motion as an elastic body in a viscous fluid. (For details, see Example 3 described below.)

The curve adjustment section 202b outputs the new curve to the image generation section 202c and the post-processing section 202d. The image generation section 202c generates, based on the new curve and the volume data, an image visualizing the tissues on the curve, such as a volume rendering image, an MPR image, or a CPR image, and then outputs the generated image to the post-processing section 202d.

The post-processing section 202d superimposes the new image output from the curve adjustment section 202b on the image output from the image generation section 202c and then outputs the superimposed image to a display 204.

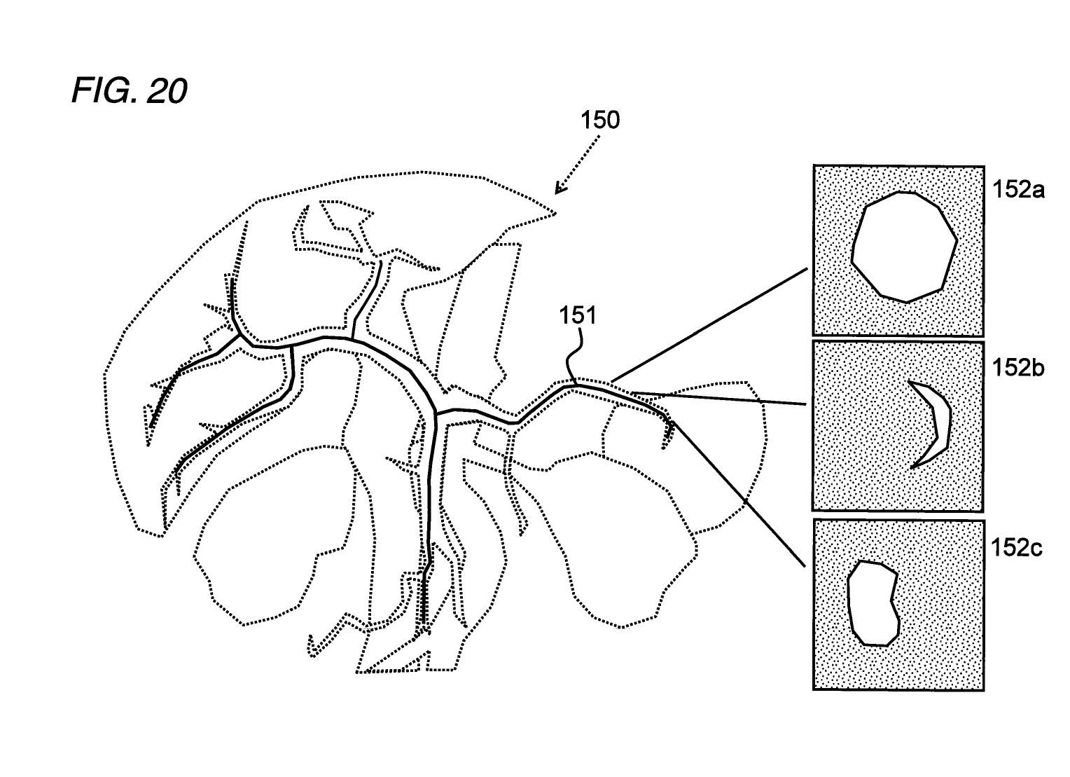

The display 204 shows a medical image (FIG. 20), or an animation representing a plurality of images in sequence.

The user interface section 203 accepts user's operation via a pointing device such as a keyboard, a mouse and generates a control signal responsive to the user's operation and supplies the control signal to each functional block. Accordingly, while seeing the image on the display 204, the user can appropriately set a curve representing the path of a colon, and can observe the lesion in detail.

### EXAMPLE 1

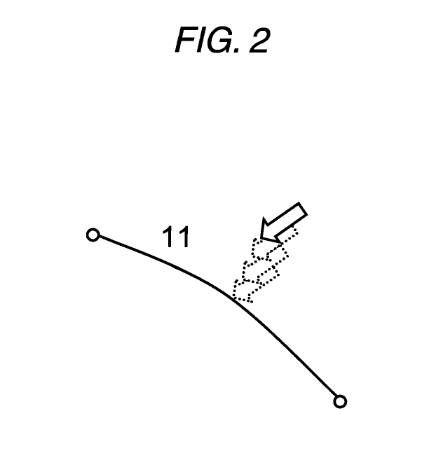

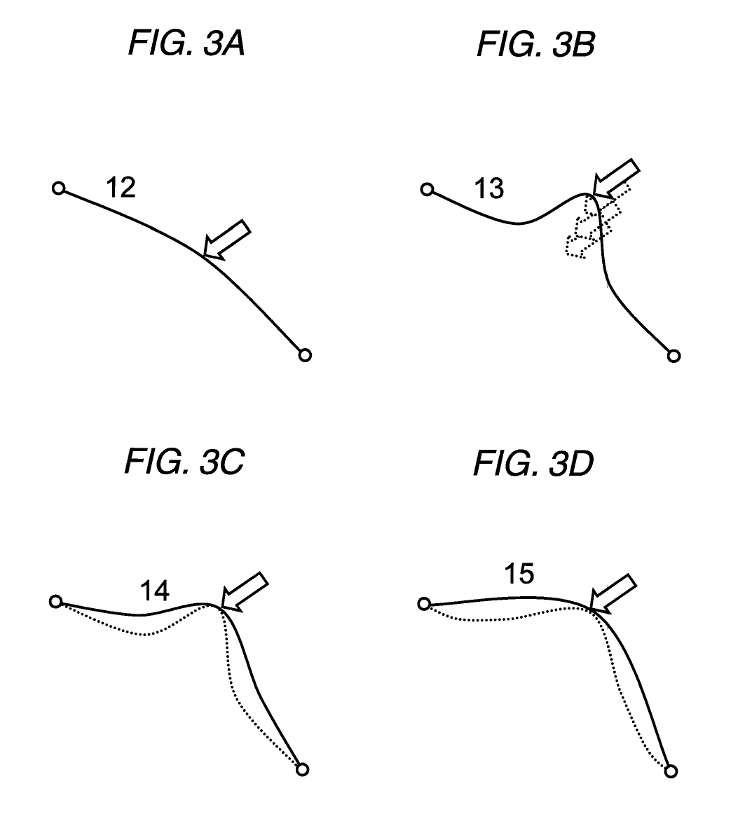

FIGS. 2 to 3D are the drawings to describe the case where a curve set in a three-dimensional space containing volume data is operated according to the time required for mouse operation in Example 1 of the exemplary embodiment. That is, as shown in FIG. 2, if the user moves a point on a curve 11 by dragging, the curve is operated according to the time required for the dragging. The curve is in a three-dimensional space. A medical image to be superimposed with the curve is omitted hereinafter.

A point in the three-dimensional space can be moved using any method. For example, if the user performs a point move operation with the mouse on an MPR image, the position of the point in the three-dimensional space on the volume data corresponding to the moved point on the MPR image becomes the position of the point after the move operation. This also applies to CPR. For example, if the user performs a point move operation with the mouse on an image obtained by rendering volume data, the position becomes the position of the point after the move operation on the volume data corresponding to the point after the move operation on the image obtained by volume rendering. As the position of the point after the move operation on the volume data, the position of the point on the volume data having the largest effect on the pixel value on a virtual ray used to calculate the pixel value where the point of the image exists can be used. For example, when using a MIP method, the position where the voxel having the maximum value on the virtual ray exists is applied. It can be also assumed that the moved point has been moved on the plane containing the point and orthogonal to the sight line direction. Any other voxel picking method shall be useful.

FIG. 3A shows a state in which the user starts dragging the mouse for a point on a curve 12, i.e., a state in which the user presses the mouse button down (time t1). FIG. 3B shows a state of a curve 13 just after the user moves the mouse cursor with the mouse button held down. FIG. 3C shows a state in which time has passed since the state of FIG. 3B with the mouse button is held down by the user. FIG. 3D shows a state of a curve 14 when the user sets the mouse button up and completes the mouse operation (time t2). Thus, the curves 13, 14, and 15 are gradually changed so long as the user holds the mouse button pressed down after moving the mouse cursor. The curve 15 is determined according to the time (t2-t1) required for the whole mouse drag operation. The process in which the curve changes as shown in FIGS. 3A to 3D is displayed on a screen (in the example, display 204).

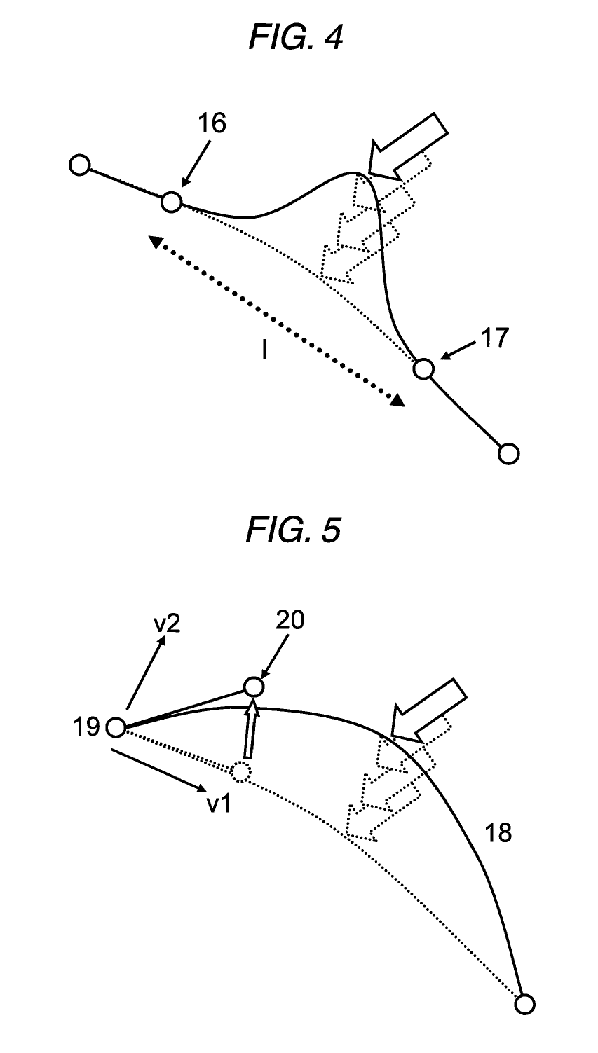

FIG. 4 is the drawing to describe a curve changing method 1 in Example 1 of the exemplary embodiment. The range sandwiched between snap points 16 and 17 is changed by a mouse operation. Therefore, the distance 1 of the curve sandwiched between the snap points 16 and 17 is determined in response to the time (t2-t1) required for the mouse operation. The distance 1 of the range between the snap points 16 and 17 is determined according to the following expression:

1=a*(t2−t1) (a: Constant) (1)

FIG. 5 is the drawing to describe a curve changing method 2 in Example 1 of the exemplary embodiment. The direction of a curve 18 on an end point 19 of the curve 18 is changed by a mouse operation. Therefore, a direction v of the curve on the end point 19 of the curve 18 is determined in response to the time (t2-t1) required for the mouse operation. The direction v of the curve on the end point 19 of the curve 18 is determined according to the following expression.

v=v1*cos(a(t2−t1))+v2*sin(a(t2−t1)), (2)

where v1 and v2 are each a vector in a three-dimensional space.

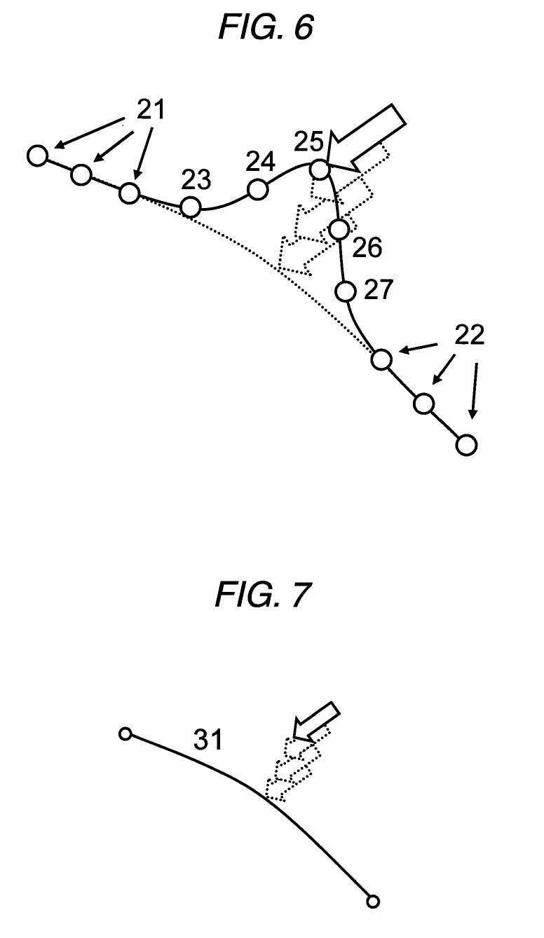

FIG. 6 is the drawing to describe a curve changing method 3 in Example 1 of the exemplary embodiment. Other nodes 23 to 27 may be present on a curve in the range sandwiched between fixed points 21 and 22. In this case, a movable node and an unmovable node are determined in response to the time (t2-t1) required for the mouse operation.

Thus, the curve can be determined according to the time required for user's mouse operation. According to the exemplary embodiment, the longer the time taken for operation, the wider the range affected by the operation. Thus, the operation result on which the intuition of the user is reflected is provided. The curve changing process is displayed on the screen and the user can complete the operation when the shape of the curve required by the user is obtained, so that the operation result on which the intuition of the user is reflected is provided.

### EXAMPLE 2

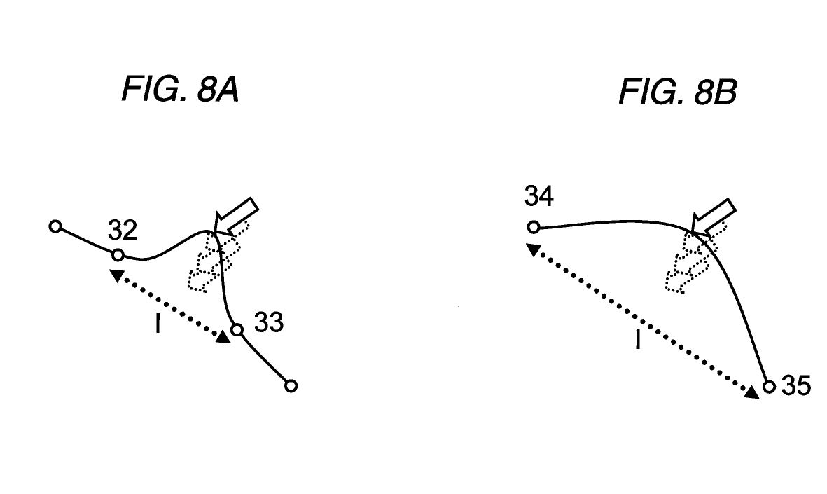

FIGS. 7 to 8B are the drawings to describe the case where a curve 31 is operated according to the mouse dragging speed in Example 2 of the exemplary embodiment. As shown in FIG. 7, when the user drags a point on the curve 31, the user operates the curve 31 according to the mouse dragging speed.

The expression “mouse dragging speed” means move speed when the user substantially moves the mouse cursor. For example, it can be the maximum speed when the mouse cursor is moved or a speed obtained by dividing a move distance by the time between start and end time of moving the mouse cursor. That is, it is not average speed containing the halt time after ending moving the mouse cursor. This is what Example 1 discloses.

FIG. 8A shows the case where dragging speed “s” is high and FIG. 8B shows the case where dragging speed “s” is low. In the example, a distance 1 of the range between snap points 32 and 33 and a distance 1 of the range between snap points 34 and 35 are determined in response to the mouse dragging speed “s”. The respective distances 1 are determined as follows:

1=a/s (a: Constant) (3)

The curve is changed in response to the dragging speed (in other words, the mouse dragging speed).

### EXAMPLE 3

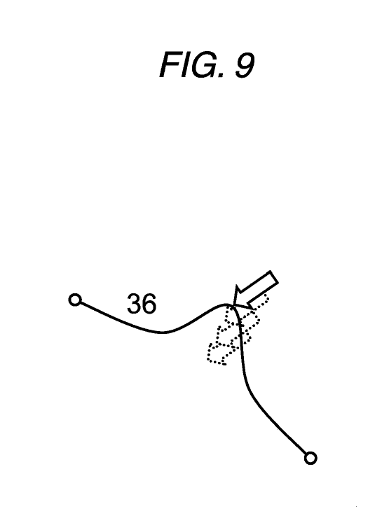

FIG. 9 is the drawing to describe the case where a curve 36 is operated by performing physical simulation in Example 3 of the exemplary embodiment. Motion of the curve 36 is simulated as an elastic body in a viscous fluid, whereby operation matching the intuition of the user can be performed. In this case, if the user moves the mouse cursor slowly, immediately the curve 36 follows the motion. On the other hand, if the user moves the mouse cursor quickly, the curve 36 follows the motion with a delay. The user halts moving the mouse cursor and waits, whereby the operation has an effect in a wide range.

### EXAMPLE 4

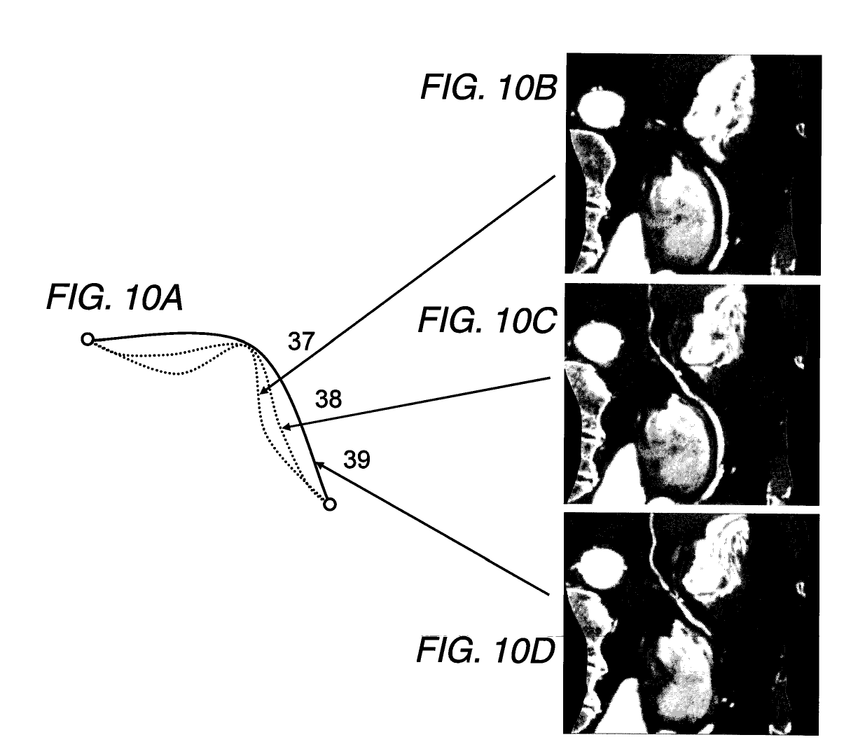

FIG. 10 is the drawing to describe the case where an image depending on a curve is updated during operation in Example 4 of the exemplary embodiment. In this case, the image depending on the curve is dynamically calculated and rendered in sequence according to the changed curve. For example, when the curve shown in FIG. 10A is changed like reference numerals 37 to 39, a CPR image is dynamically calculated and rendered in sequence as shown in FIGS. 10B to 10D. In this case, the user can set an appropriate curve while observing the image depending on the curve rather than the curve itself.

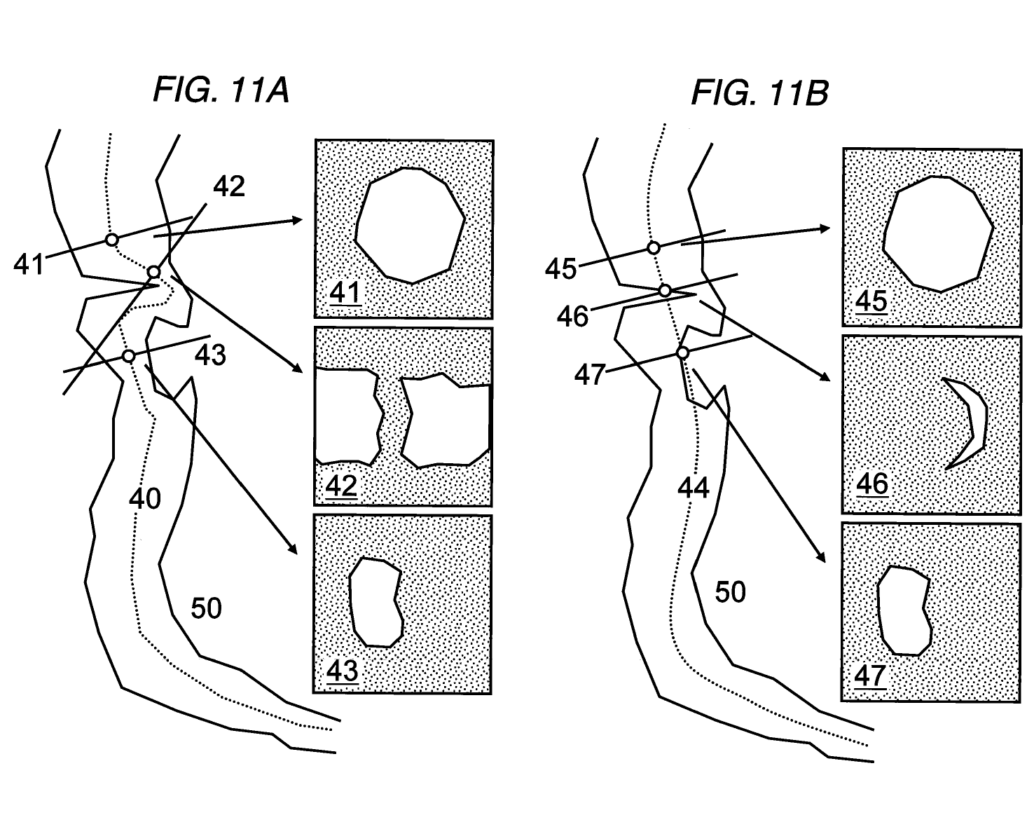

FIG. 11 is a drawing to describe the effect of Example 4. In Example 4, depending on change in the center line of an object, the respective orthogonal sections corresponding to the center line changes. For example, in FIG. 11A, the respective images corresponding to orthogonal sections 41 to 43 on a center line 40 are shown. In FIG. 11B, the respective images corresponding to orthogonal sections 45 to 47 on a center line 44 are shown. Thus, the user can operate the curve while seeing the images of the orthogonal sections 41 to 43, 45 to 47.

As images depending on a curve, an MPR image corresponding to a plane orthogonal to the curve, a CPR image corresponding to the curve, and a curved cylindrical projection method (CCPM) image corresponding to the curve are conceivable (see e.g., US2006/0221074A1). A curve can be also displayed in the respective images depending on the curve and can also be operated on the respective images depending on the curve. Thus, if an image depending on a plurality of curves is present, flexibility operation can be performed. For example, when the intersection point of an orthogonal section and a curve is moved on the orthogonal section, change in a CPR image corresponding to the curve can be checked.

In addition, information can be also calculated for display. For example, the information may be the length of a curve (or the distance from the specified point). Also, When a curve represents the center line of a blood vessel, the information may be, for example, the cross-sectional area, the stenosis ratio, the blood vessel diameter, and the region of the blood vessel. It is also possible in other organs such as digestive organs and lungs.

### EXAMPLE 5

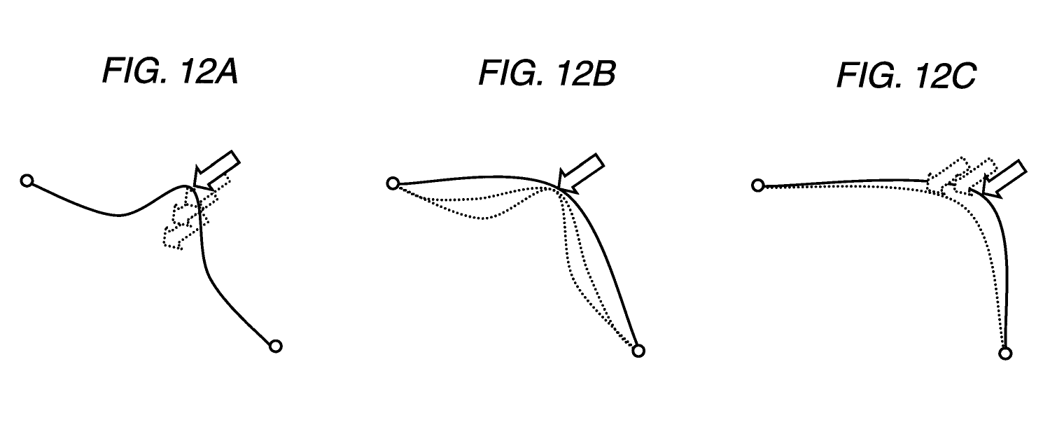

FIGS. 12A to 12C are the drawings to describe the case where mouse cursor is additionally moved while a curve is changing in Example 5 of the exemplary embodiment. The user can make a correction at any time to obtain a more appropriate curve while observing the changing curve. For example, the user can drag the mouse in the diagonal upper right direction as shown in FIG. 12A to create a curve shown in FIG. 12B and then can drag the mouse in the right direction as shown in FIG. 12C to create a curve of a different shape. That is, the point specified by the mouse cursor is moved gradually.

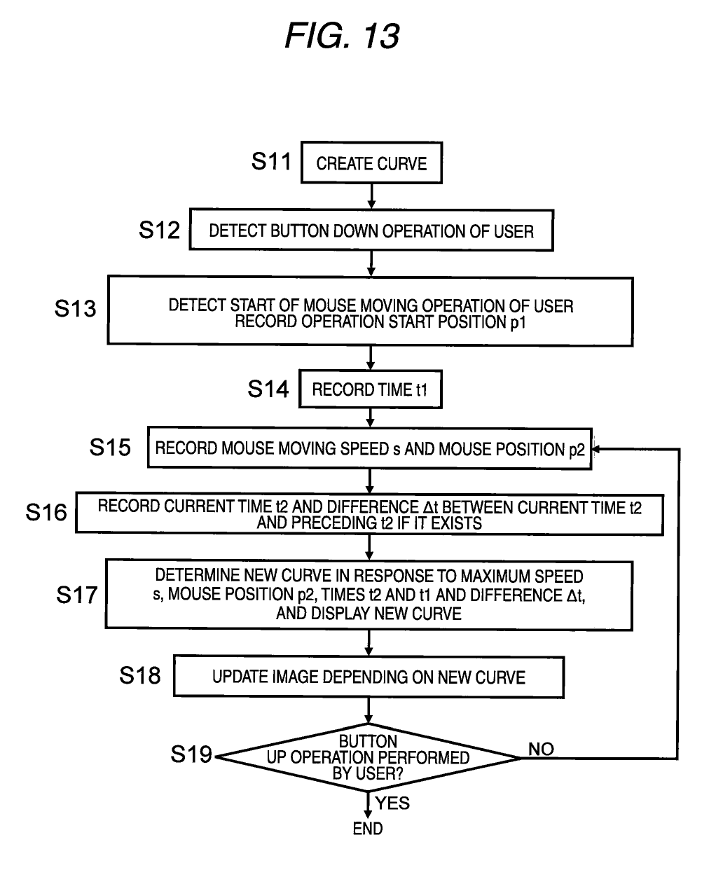

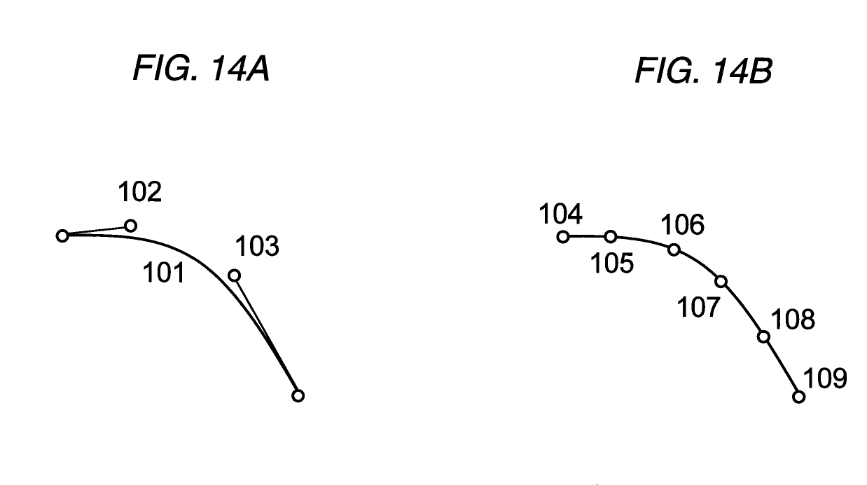

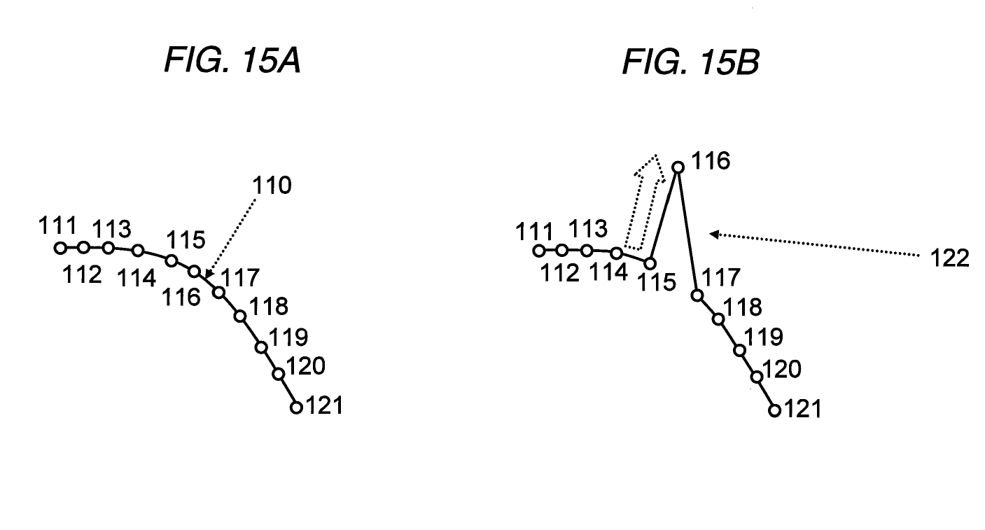

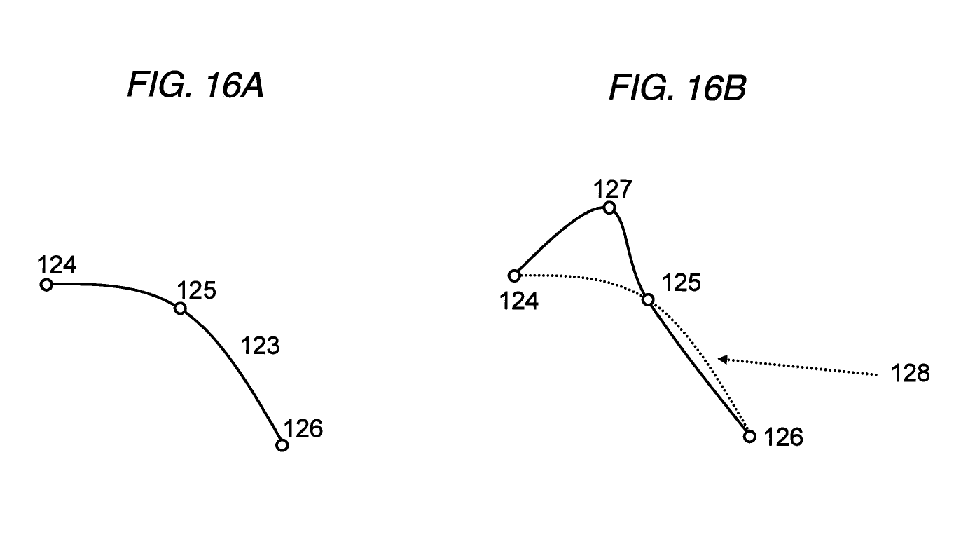

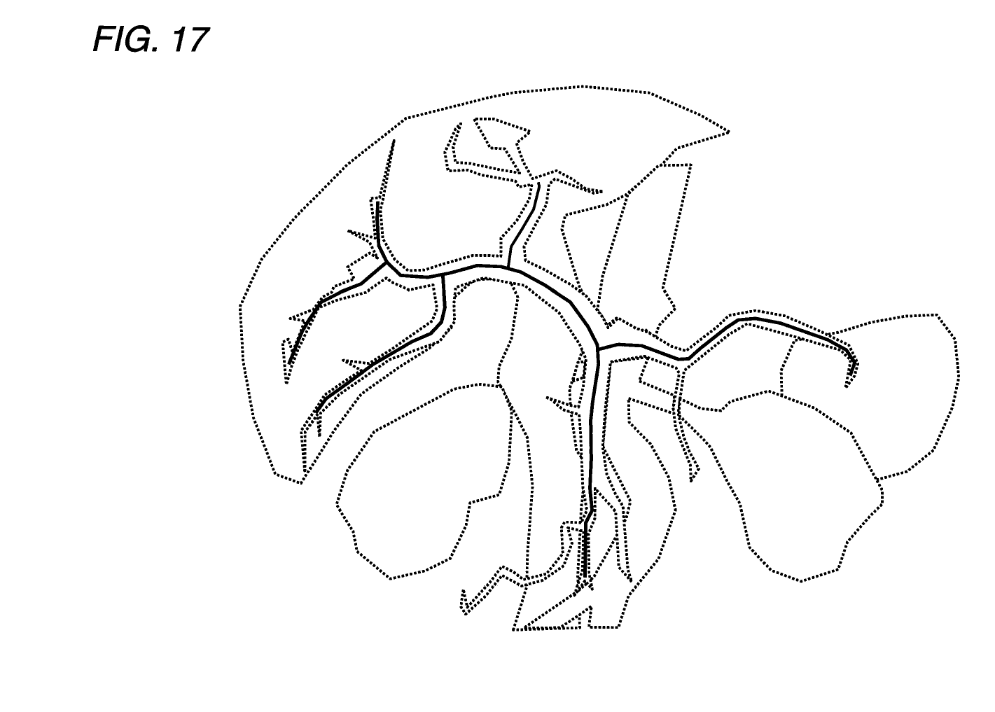

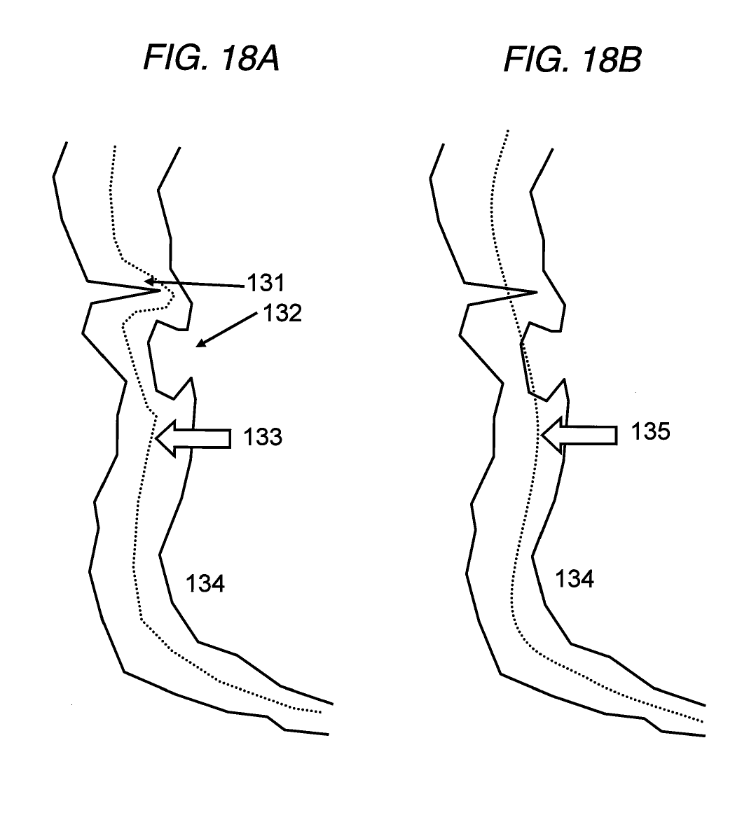

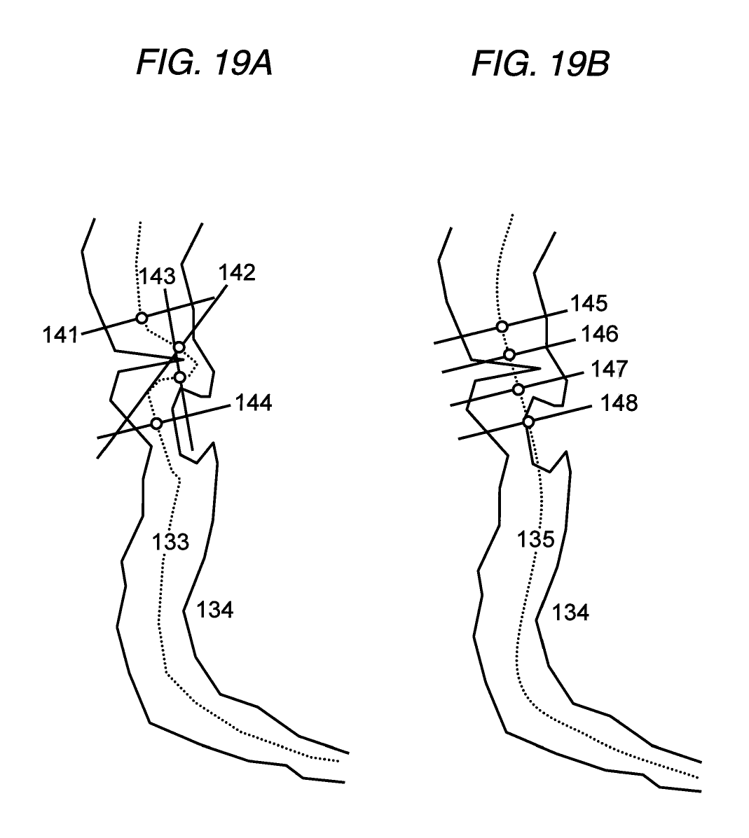

FIG. 13 is the flowchart to describe a curve correction method according to the exemplary embodiment of the invention. To create a curve (step S1), button down operation of the user is detected (step S12). Start of mouse moving operation of the user is detected and an operation start position p1 is recorded (step S13) and subsequently time t1 (corresponding to the first time) is recorded (step S14).

Next, mouse moving speed s and the mouse position p2 are recorded (step S15) and further current time t2 (corresponding to a second time) is recorded (step S16).

Next, a new curve is determined in response to the maximum speed s, the mouse position p2, and the times t2 and t1 and then is displayed (step S17). The image depending on the curve is updated (step S18) and button up operation of the user is detected (step S19).

If it is not determined at step S19 that the user performs button up operation (NO), the system waits for the passage of a given time (or detects mouse move, etc.,) and returns to step S15. At step S16 at the second time or later, when new current time t2 (corresponding to a third time) is recorded, time difference At from the preceding time t2 is recorded. At step S17 at the second time or later, a new curve is determined in response to the difference At in addition to the maximum speed s, the mouse position p2, and the times t2 and t1. On the other hand, if it is determined at step S19 that the user performs button up operation (YES), the process is complete.

Thus, according to the curve correction method shown in the exemplary embodiment of the invention, when the user operates a curve, the motion required for the operation is used as a parameter. Therefore, when a curve set mainly by the tracking algorithm is adjusted or corrected, the user can perform intuitive and easy operation and can also obtain any desired curve regardless of the number of nodes.

The curve correction method of the exemplary embodiment can be also applied to a curved surface.

The time t1 may be the start time of button down or mouse move. If the mouse move is restarted after the mouse move is once halted, t1 may be set to the halt time of the second mouse move. Furthermore, clicking twice rather than button down and button up for drag operation can be applied to the exemplary embodiment of the invention. Key operation of the keyboard rather than mouse button operation can be applied to the exemplary embodiment of the invention.

Any pointing device other than the mouse can be also applied to the exemplary embodiment of the invention. For example, any pointing device such as a track ball, a touch pen, or a joy stick can be used.

The curve correction method of the exemplary embodiment is directed to a curve on volume data in a three-dimensional space, but may be directed to a curve of image information on a CPR image, an MPR image, or a simple slice image. If a plurality of two-dimensional images are present in a three-dimensional space, the curve correction method of the exemplary embodiment may be directed to a curve across the images.

Also, the curve correction method of the exemplary embodiment may be executed by a computer program stored on a computer-readable medium. For example, when the program is executed, it causes the computer to perform the curve correction method of the exemplary embodiment.

While the present invention has been shown and described with reference to certain exemplary embodiments thereof, it will be understood by those skilled in the art that various changes in form and details may be made therein without departing from the spirit and scope of the invention as defined by the appended claims. It is aimed, therefore, to cover in the appended claim all such changes and modifications as fall within the true spirit and scope of the present invention.

What is claimed is:

1. A medical image processing method for manipulating a curve using a pointing device, the method comprising:
(a) accepting a first point on the curve specified by the pointing device;
(b) reading a first time;
(c) reading a second time when a point specified by the pointing device is moved to a second point from the first point;
(d) determining a new curve based on a position of the second point, the second time, and the first time;
(e) displaying said new curve;
(f) reading a third time and a third point specified by the pointing device;
(g) determining a further new curve based on a position of the third point, the third time, and the first time or the second time; and
(h) displaying said further new curve.

2. The medical image processing method as claimed in claim 1, further comprising:
(i) displaying information using the further new curve.

3. The medical image processing method as claimed in claim 2, wherein the information is an image using volume data.

4. The medical image processing method as claimed in claim 3, wherein the image is an MPR image or a CPR image.

5. The medical image processing method as claimed in claim 1, wherein the position of the second point is different from the position of the third point.

6. The medical image processing method as claimed in claim 1, further comprising:
(i) reading a moving speed of the pointing device when the pointing device is moved from the first point,
wherein step (g) comprises:
determining the further new curve based on the moving speed in addition to the position of the third point, the third time and the first time or second time.

7. The medical image processing method as claimed in claim 1, wherein step (d) comprises: determining the new curve by simulating a curve motion as an elastic body in a viscous fluid.

8. The medical image processing method as claimed in claim 1, wherein the curve, the new curve and the further new curve are set in a three-dimensional space.

9. The medical image processing method as claimed in claim 1, wherein the curve, the new curve and the further new curve are set in a three-dimensional space on volume data.

10. The medical image processing method as claimed in claim 1, wherein the position of the second point is the same as the position of the third point.

11. A medical imaging apparatus, comprising:
a volume data generating section that generates volume data;
a curve generation section that generates a curve based on the volume data;
a user interface section that generates a control signal in response to a signal from a pointing device;
a curve adjustment section that manipulates the curve generated in the curve generation section based on the control signal generated in the user interface section, the curve adjustment section comprising:
a first time record processing section that records a first time when a first position on the curve specified by the pointing device is accepted;
a second time record processing section that records a second time when a point specified by the pointing device is moved to a second point from the first point;
a third time record processing section that records a third time when a point specified by the point device is moved to a third point from the second point; and
a curve determination processing section that determines: (i) a new curve based on a position of the second point, the second time and the first time; and (ii) a further new curve based on a position of the third point, the third time, and the first time or the second time, and
a display section that displays the new curve or the further new curve.

12. The medical imaging apparatus as claimed in claim 11, wherein the display section displays information using the further new curve.

13. The medical imaging apparatus as claimed in claim 12, wherein the information is an image using volume data.

14. The medical imaging apparatus as claimed in claim 13, wherein the image is an MPR image or a CPR image.

15. The medical imaging apparatus as claimed in claim 11, wherein the position of the second point is different from the position of the third point.

16. The medical imaging apparatus as claimed in claim 11, wherein the curve adjustment section further comprises: a moving speed record processing section that reads a moving speed of the pointing device when the pointing device is moved from the first point, and
wherein the curve determination processing section determines the further new curve based on the moving speed in addition to the position of the third point, the third time and the first time or second time.

17. The medical imaging apparatus as claimed in claim 11, wherein the curve determination processing section determines the new curve by simulating a curve motion as an elastic body in a viscous fluid.

18. The medical imaging apparatus as claimed in claim 11, wherein the curve, the new curve and the further new curve are set in a three-dimensional space.

19. The medical imaging apparatus as claimed in claim 11, wherein the curve, the new curve and the further new curve are set in a three-dimensional space on volume data.

20. The medical imaging apparatus as claimed in claim 11, wherein the position of the second point is the same as the position of the third point.
